(19) United States
(12) Patent Application Publication
(10) Pub. No.: US 2024/0153138 A1
(43) Pub. Date: May 9, 2024

(54) METHODS, SYSTEMS, AND COMPUTER-READABLE STORAGE MEDIUMS FOR POSITIONING TARGET OBJECT

(71) Applicant: ZHEJIANG HUARAY TECHNOLOGY CO., LTD., Hangzhou (CN)

(72) Inventors: Jing LI, Hangzhou (CN); Rui YU, Hangzhou (CN); Lu ZHOU, Hangzhou (CN)

(73) Assignee: ZHEJIANG HUARAY TECHNOLOGY CO., LTD., Hangzhou (CN)

(21) Appl. No.: 18/414,409

(22) Filed: Jan. 16, 2024

Related U.S. Application Data
(63) Continuation of application No. PCT/CN2022/110284, filed on Aug. 4, 2022.

(30) Foreign Application Priority Data
Aug. 9, 2021 (CN) 202110905411.5

(51) Int. Cl. G06T 7/73; G06T 1/00; G06V 10/74; G06V 10/764; G06V 10/77; G06V 10/80

(52) U.S. Cl. CPC G06T 7/74; G06T 1/0014; G06V 10/761; G06V 10/764; G06V 10/7715; G06V 10/806; G06T 2207/30164; G06V 2201/06

(57) ABSTRACT

The embodiments of the present disclosure provide a method for positioning a target object. The method may include: determining an identification result by processing an image based on an identification model, wherein the identification result includes a first position of each of at least one target object in a first coordinate system; determining, from the image, a target image of each of the at least one target object based on the first position of each of the at least one target object in the first coordinate system; and determining, based on a first reference image and the target image of each of the at least one target object, a second position of each of the at least one target object in a second coordinate system, wherein the second position is configured to determine operation parameters of an operating device.

### CROSS-REFERENCE TO RELATED APPLICATION

This application is a continuation of International Application No. PCT/CN2022/110284, filed on Aug. 4, 2022, which claims priority of Chinese Patent Application No. 202110905411.5, filed on Aug. 9, 2021, the contents of which are entirely incorporated herein by reference.

### TECHNICAL FIELD

The present disclosure relates to the field of data processing, and in particular, to methods, systems, and computer-readable storage mediums for positioning a target object.

### BACKGROUND

With the development of modern production technology, automated production has become an inevitable trend. In current automated production, products on a conveyor belt on a production line need to be identified and positioned, so that an operating device (e.g., a robotic arm) may operate the products. However, current target object identifying and positioning methods have poor performance in identifying scenes where there are a plurality of stacked target objects.

Therefore, it is desirable to provide methods, systems, and mediums for positioning a target object in a scene where there are a plurality of stacked target objects, so as to facilitate an operating device to operate subsequently.

### SUMMARY

One of the embodiments of the present disclosure provides a method for positioning a target object. The method may include: determining an identification result by processing an image based on an identification model, wherein the identification result includes a first position of each of at least one target object in a first coordinate system; determining, from the image, a target image of each of the at least one target object based on the first position of each of the at least one target object in the first coordinate system; and determining, based on a first reference image and the target image of each of the at least one target object, a second position of each of the at least one target object in a second coordinate system, wherein the second position is configured to determine operation parameters of an operating device.

One of the embodiments of the present disclosure provides a system for positioning a target object. The system may include: at least one computer-readable storage medium including a set of instructions for positioning a target object; and at least one processor in communication with the computer-readable storage medium, wherein when executing the set of instructions, the at least one processor is configured to: determine an identification result by processing an image based on an identification model, wherein the identification result includes a first position of each of at least one target object in a first coordinate system; determine, from the image, a target image of each of the at least one target object based on the first position of each of the at least one target object in the first coordinate system; and determine, based on a first reference image and the target image of each of the at least one target object, a second position of each of the at least one target object in a second coordinate system, wherein the second position is configured to determine operation parameters of an operating device.

One of the embodiments of the present disclosure provides a system for a target object. The system may include: a result determination module configured to determine an identification result by processing an image based on an identification model, wherein the identification result includes a first position of each of at least one target object in a first coordinate system; an image determination module configured to determine, from the image, a target image of each of the at least one target object based on the first position of each of the at least one target object in the first coordinate system; and a position determination module configured to determine, based on a first reference image and the target image of each of the at least one target object, a second position of each of the at least one target object in a second coordinate system, wherein the second position is configured to determine operation parameters of an operating device.

One of the embodiments of the present disclosure provides a computer-readable storage medium storing a set of computer instructions. When executed by at least one processor, the set of instructions direct the at least one processor to effectuate a method, the method comprising: determining an identification result by processing an image based on an identification model, wherein the identification result includes a first position of each of at least one target object in a first coordinate system; determining, from the image, a target image of each of the at least one target object based on the first position of each of the at least one target object in the first coordinate system; and determining, based on a first reference image and the target image of each of the at least one target object, a second position of each of the at least one target object in a second coordinate system, wherein the second position is configured to determine operation parameters of an operating device.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary target object positioning system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary target object positioning system according to some embodiments of the present disclosure;

FIG. 5 is a flowchart illustrating an exemplary process for positioning a target object according to some embodiments of the present disclosure;

FIG. 6 is a schematic diagram illustrating an exemplary identification model according to some embodiments of the present disclosure;

FIG. 7 is a flowchart illustrating an exemplary process for determining an operating order in which an operating device works on a target object according to some embodiments of the present disclosure;

FIG. 8 is a flowchart illustrating an exemplary process for determining a second position of at least one target object in a second coordinate system according to some embodiments of the present disclosure;

FIG. 9A is a schematic diagram illustrating an exemplary image according to some embodiments of the present disclosure;

FIG. 9B is a schematic diagram illustrating an exemplary object frame in a first coordinate system where a plurality of target objects in an image are located according to some embodiments of the present disclosure;

FIG. 9C is a schematic diagram illustrating an exemplary target image of a target object according to some embodiments of the present disclosure; and

FIG. 10 is a flowchart illustrating an exemplary process for identifying and positioning a plurality of target objects according to some embodiments of the present disclosure.

### DETAILED DESCRIPTION

In order to more clearly illustrate the technical solutions related to the embodiments of the present disclosure, brief introduction of the drawings referred to the description of the embodiments is provided below. Obviously, drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily performed exactly in order. Instead, the operations may be processed in reverse order or simultaneously. Besides, one or more other operations may be added to these processes, or one or more operations may be removed from these processes.

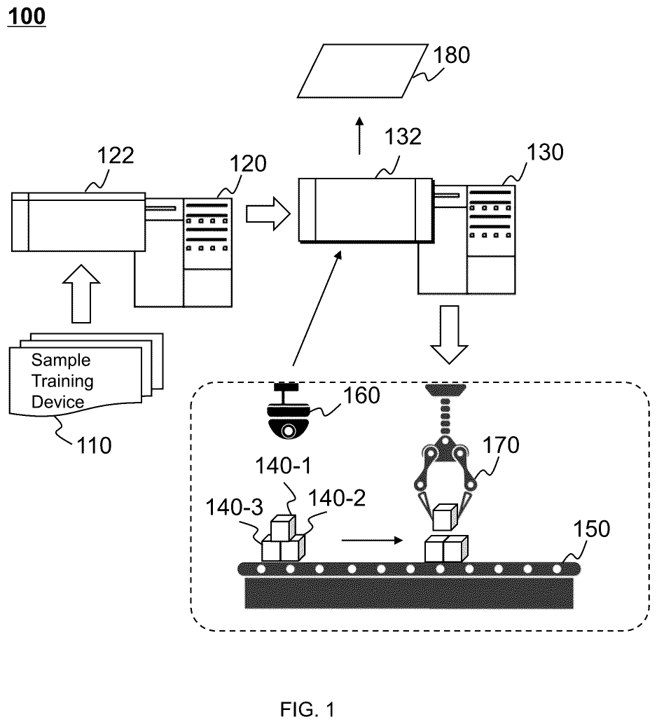

FIG. 1 is a schematic diagram illustrating an exemplary target object positioning system 100 according to some embodiments of the present disclosure.

As shown in FIG. 1, the target object positioning system 100 may include a sample training device 110, a first computing system 120, a second computing system 130, a target object 140-1, a target object 140-2, a target object 140-3, a conveyor belt 150, an image obtaining device 160, and an operating device 170.

The first computing system 120 and the second computing system 13 may refer to systems with computing capabilities, such as a server, a personal computer, or a computing platform including a plurality of computers in various structures. The first computing system 120 and the second computing system 130 may be the same or different.

The first computing system 120 and the second computing system 13 may include at least one computer-readable storage medium. The computer-readable storage medium may store instructions. For example, the stored instructions may be a set of instructions for positioning a target object. The computer-readable storage medium may also store data. For example, the computer-readable storage medium may store a first reference image and a second reference image. The computer-readable storage medium may include a mass storage device, a removable storage device, a volatile read-and-write memory, a read-only memory (ROM), or the like, or any combination thereof.

The first computing system 120 and the second computing system 130 may include at least one processor in communication with a computer-readable storage medium. When executing the set of instructions, the at least one processor may implement a method for positioning the target object described in the embodiments of the present disclosure. The at least one processor may include various common central processing unit, a graphics processing unit, a micro-processing unit, etc.

The first computing system 120 may include a model 122. The first computing system 120 may obtain the sample training device 110, and update parameters of the model 122 based on the sample training device 110 to obtain a trained model. The sample training device 110 may include labels with the training sample. The sample training device 110 may enter the first computing system 120 by various common ways.

The second computing system 130 may include a model 132, and parameters of the model 132 may be derived from the trained model 122. The parameters may be transmitted in any common way. The second computing system 130 may generate a result 180 based on the model 132, and the result 180 may be a result obtained after the model 132 processes input data. The data used for training may be the same as or different from the data used by the second computing system 130 to determine an identification result.

A model (e.g., the model 122 or/and the model 132) may refer to a collection of several methods performed based on a processing device. The methods may include a large number of parameters. When the model is executed, the parameters may be preset or may be dynamically adjusted. Some parameters may be obtained by training. Some parameters may be obtained during execution. For the specific description regarding the model involved in the present disclosure, please refer to the relevant parts of the present disclosure.

The target objects 140-1, 140-2, and 140-3 may refer to objects that need to be positioned on the conveyor belt 150 of the production line.

The conveyor belt 150 may refer to a device configured to convey a target object in a designated direction. One or more target objects may be included on the conveyor belt 150. As shown in FIG. 1, the target object 140-1, the target object 140-2, and the target object 140-3 may be included on the conveyor belt 150.

The image obtaining device 160 may be a device configured to obtain an image. For example, the image obtaining device may be a camera.

The operating device 170 may be a device that works on a target object. For example, the operating device 170 may be a robotic arm. The target objects 140-1, 140-2, and 140-3 may be cosmetic packaging boxes conveyed on the conveyor belt 150. The robotic arm may be configured to grab each cosmetic packaging box to transfer each cosmetic packaging box to a packaging case.

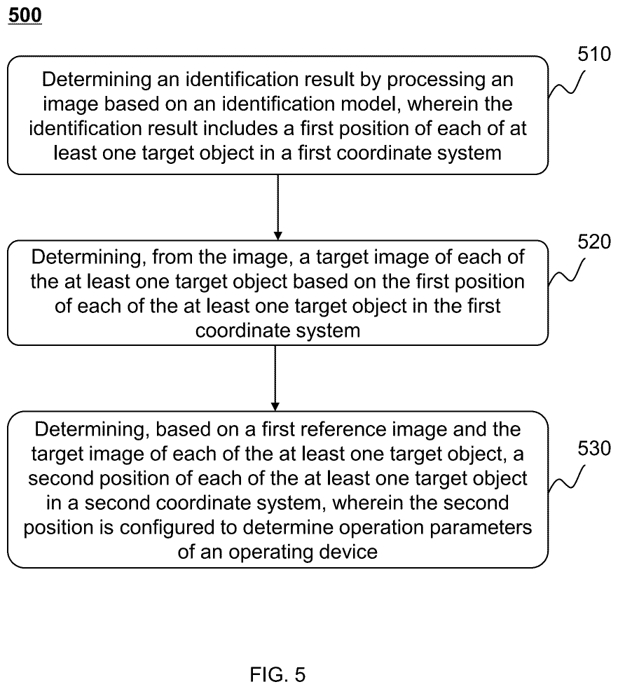

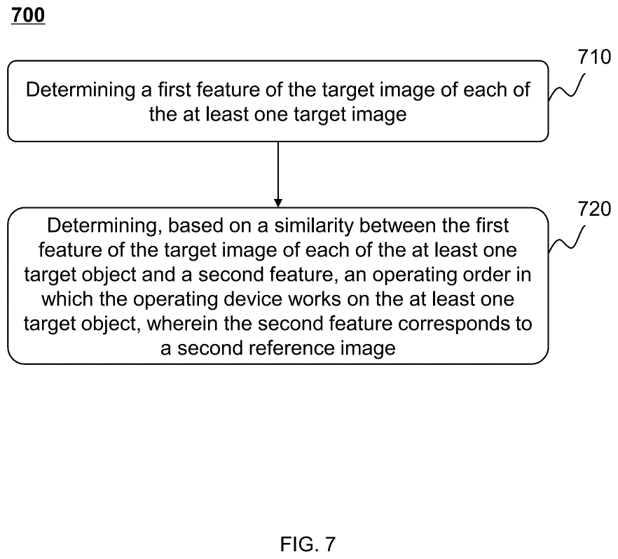

The first computing system 120, the second computing system 130, the image obtaining device 160, and the operating device 170 may perform data interaction. For example, the first computing system 120, the second computing system 130, the image obtaining device 160, and the operating device 170 may communicate with each other by various feasible ways (e.g., a network) to facilitate data exchange. In some embodiments, the second computing system 130 may obtain relevant data of the image obtaining device 160 and obtain a result 180 by processing the data. In some embodiments, the second computing system 130 may determine an operation parameter of the operating device 170 based on the result 180, and control the operating device 170 to work based on the operation parameter. More descriptions regarding the determining the operation parameter may be found in FIG. 5 and relevant descriptions thereof. In some embodiments, the second computing system 130 may also determine an operating order for performing work on at least one target object based an image. The second computing system 130 may control the operating device 170 to work on the at least one target object based on the operating order. More descriptions regarding the determining the operating order for performing work on the at least one target object may be found in FIG. 7 and relevant descriptions thereof.

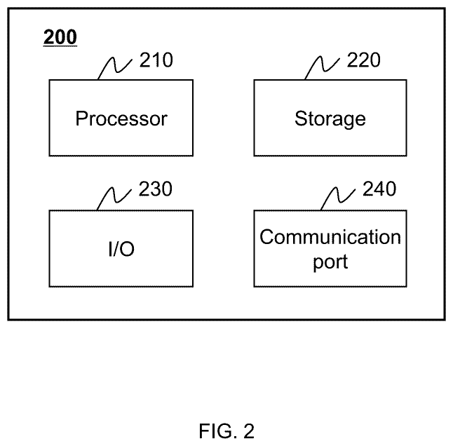

FIG. 2 is a schematic diagram illustrating hardware and/or software components of an exemplary computing device according to some embodiments of the present disclosure. As illustrated in FIG. 2, the computing device 200 may include a processor 210, a storage 220, an input/output (I/O) 230, and a communication port 240. In some embodiments, the computing device 200 may be used to implement any component (e.g., the first computing system 120, the second computing system 130, the image obtaining device 160, the operating device 170) of the target object positioning system 100 that performs one or more functions disclosed in the present disclosure.

The processor 210 may execute computer instructions (program code) and, when executing the instructions, cause the first computing system 120 and/or the second computing system 130 to perform functions of the first computing system 120 and/or the second computing system 130 in accordance with techniques described herein. The computer instructions may include, for example, routines, programs, objects, components, signals, data structures, procedures, modules, and functions, which perform particular functions described herein. In some embodiments, the processor 210 may include one or more hardware processors, such as a microcontroller, a microprocessor, a reduced instruction set computer (RISC), an application-specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field-programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both process A and process B, it should be understood that process A and process B may also be performed by two or more different processors jointly or separately in the computing device 200 (e.g., a first processor executes process A and a second processor executes process B, or the first and second processors jointly execute processes A and B).

The storage 220 may store data/information relating one or more functions disclosed in the present disclosure. In some embodiments, the storage 220 may include a mass storage device, removable storage device, a volatile read-and-write memory, a read-only memory (ROM), or the like, or any combination thereof. For example, the mass storage may include a magnetic disk, an optical disk, a solid-state drive, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program (e.g., in the form of computer-executable instructions) for the first computing system 120 and/or the second computing system 130 for positioning a target object.

The I/O 230 may input or output signals, data, and/or information. In some embodiments, the I/O 230 may enable user interaction between the computing device 200 and an external device. In some embodiments, the I/O 230 may include an input device and an output device. Exemplary input devices may include a keyboard, a mouse, a touch screen, a microphone, or the like, or a combination thereof. Exemplary output devices may include a display device, a loudspeaker, a printer, a projector, or the like, or a combination thereof. Exemplary display devices may include a liquid crystal display (LCD), a light-emitting diode (LED)-based display, a flat panel display, a curved screen, a television device, a cathode ray tube (CRT), or the like, or a combination thereof.

The communication port 240 may be connected to a network (e.g., the network 160) to facilitate data communications. The communication port 240 may establish connections between the computing device 200 and the external device. The connection may be a wired connection, a wireless connection, or a combination of both that enables data transmission and reception. The wired connection may include an electrical cable, an optical cable, a telephone wire, or the like, or any combination thereof. The wireless connection may include Bluetooth, Wi-Fi, WiMAX, WLAN, ZigBee, mobile network (e.g., 3G, 4G, 5G, etc.), or the like, or a combination thereof. In some embodiments, the communication port 240 may be a standardized communication port, such as RS232, RS485, etc. In some embodiments, the communication port 240 may be a specially designed communication port. For example, the communication port 240 may be designed in accordance with the digital imaging and communications in medicine (DICOM) protocol.

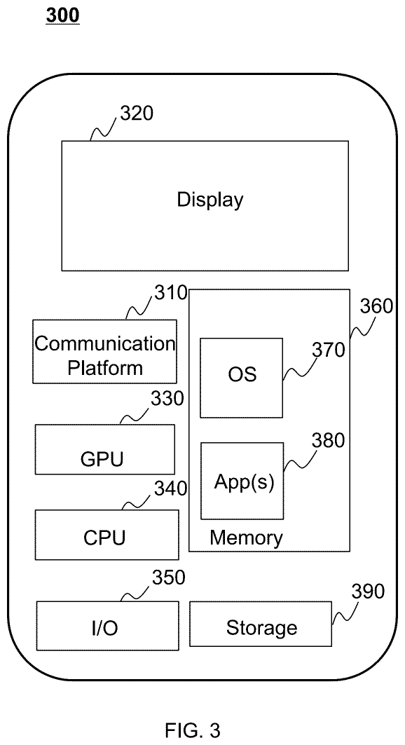

FIG. 3 is a schematic diagram illustrating hardware and/or software components of a mobile device according to some embodiments of the present disclosure. In some embodiments, the first computing system 120, the first computing system 130, and/or the image obtaining device 160 may be implemented on the mobile device 300. As illustrated in FIG. 3, the mobile device 300 may include a communication platform 310, a display 320, a graphics processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300. In some embodiments, a mobile operating system 370 (e.g., iOS, Android, Windows Phone, etc.) and one or more applications 380 may be loaded into the memory 360 from the storage 390 in order to be executed by the CPU 340. The applications 380 may include a browser or any other suitable mobile apps for receiving and rendering information relating to image processing or other information from the first computing system 120, the first computing system 130. User interactions with the information stream may be achieved via the I/O 350 and provided to the first computing system 120, the first computing system 130 and/or other components of the target object positioning system 100 via the network 160.

To implement various modules, units, and functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to generate a high-quality image of a scanned object as described herein. A computer with user interface elements may be used to implement a personal computer (PC) or another type of work station or terminal device, although a computer may also act as a server if appropriately programmed. It is believed that those skilled in the art are familiar with the structure, programming and general operation of such computer equipment and as a result, the drawings should be self-explanatory.

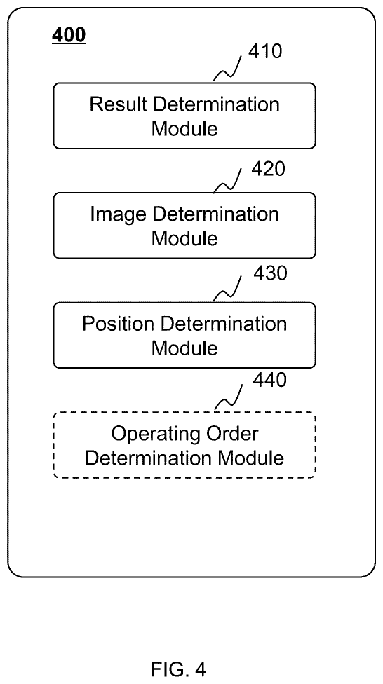

FIG. 4 is a block diagram illustrating an exemplary target object positioning system 400 according to some embodiments of the present disclosure.

As shown in FIG. 4, the target object positioning system 400 may include a result determination module 410, an image determination module 420, and a position determination module 430.

The result determination module 410 may determine an identification result by processing an image based on an identification model. The identification result may include a first position of each of at least one target object in a first coordinate system. More descriptions regarding the determining the identification result may be found in FIG. 5 and relevant descriptions.

In some embodiments, for each of the at least one target object, a representation parameter of the first position of the target object may include a direction parameter of an object frame where the target object is located and/or the plurality of position parameters of a plurality of key points of the object frame, etc. More descriptions regarding the representation parameters of the plurality of key points of the object frame may be found in FIG. 5 and relevant descriptions thereof.

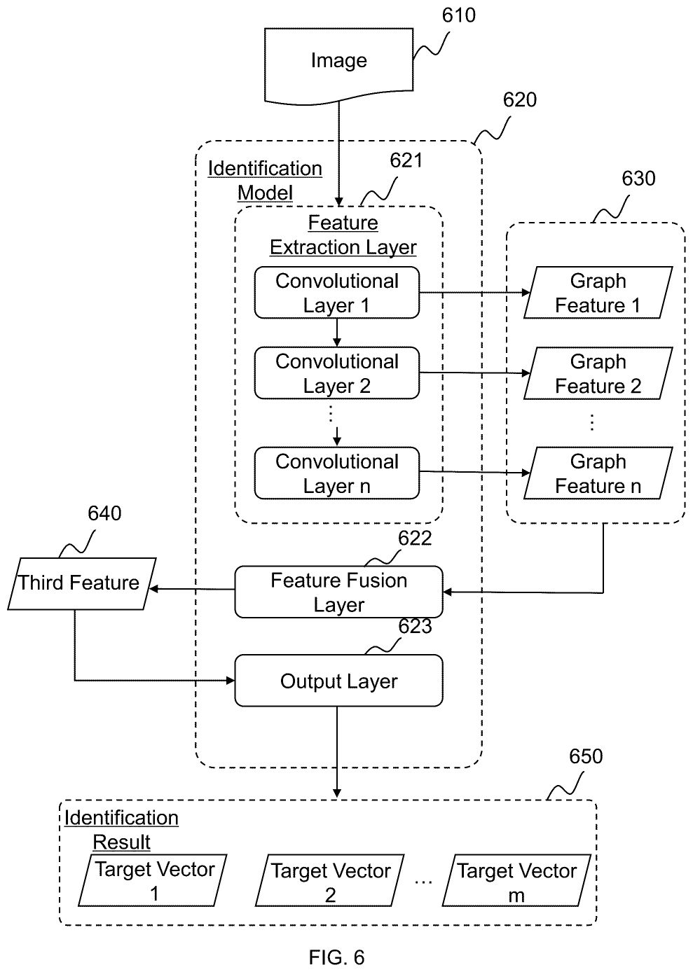

In some embodiments, the identification model may be obtained by a training process. In some embodiments, the identification model may include a feature extraction layer, a feature fusion layer, and an output layer. More descriptions regarding the training and the structure of the identification model may be found in FIG. 6 and the relevant descriptions thereof.

The image determination module 420 may determine, from the image, a target image of each of the at least one target object based on the first position of each of the at least one target object in the first coordinate system. More descriptions regarding the target image may be found in FIG. 5 and relevant descriptions thereof.

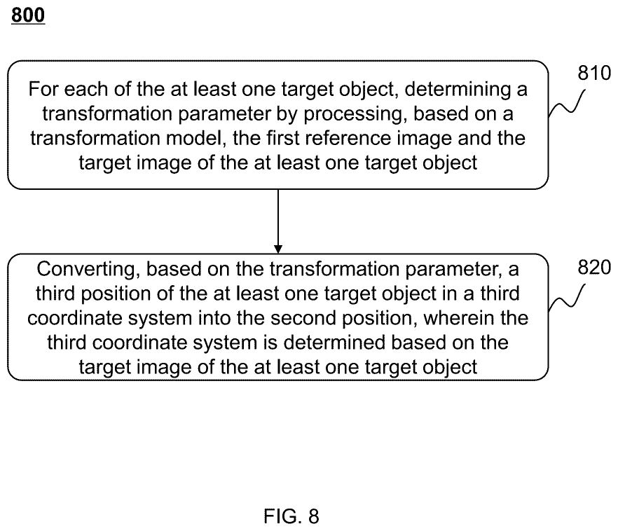

The position determination module 430 may determine, based on a first reference image and the target image of each of the at least one target object, a second position of each of the at least one target object in a second coordinate system. The second position may be configured to determine operation parameters of an operating device. More descriptions regarding the determining the second position may be found in FIG. 5 and relevant descriptions thereof. In some embodiments, for each of the at least one target objects, the position determination module 430 may determine the second position based on a transformation model and the first reference image. More descriptions regarding the determining the second position based on the transformation model and the transformation model may be found in FIG. 8 and relevant descriptions thereof.

As shown in FIG. 4, the target positioning system 400 may also include an operating order determination module 440.

The operating order determination module 440 may determine, based on a similarity between a first feature of the target image and a second feature of a second reference image, an operating order in which the operating device works on the at least one target object. More descriptions regarding the features of the target image and the second reference image may be found in FIG. 7 and relevant descriptions thereof.

It should be noted that the above descriptions of the target object positioning system and its modules is merely for the convenience of description, and not intended to limit the present disclosure to the scope of the embodiments. It will be understood that for those skilled in the art, after understanding the principle of the system, it is possible to arbitrarily combine various modules, or form a subsystem to connect with other modules without departing from the principle. In some embodiments, the result determination module 410, the image determination module 420, and the position determination module 430 disclosed in FIG. 4 may be different modules in a system, or one module that implements the functions of the two or more modules. For example, each module may share a storage module, and each module may also have its own storage module. All such modifications are within the protection scope of the present disclosure.

FIG. 5 is a flowchart illustrating an exemplary process 500 for positioning a target object according to some embodiments of the present disclosure. As shown in FIG. 5, the process 500 may include the following operations.

In 510, a processor may determine an identification result by processing an image based on an identification model.

The image may refer to an image including an object that needs to be positioned. The image may include at least one target object. The target object may refer to an object that needs to be positioned. For example, the target object may be a product on a production line that needs to be positioned. Correspondingly, the image may be an image including the product on the production line. The processor may obtain the image of the at least one target object from an image obtaining device (e.g., the image obtaining device 460).

The identification result may refer to a result obtained after the at least one target object in the image is identified. The identification result may include information of each of the at least one target object. In some embodiments, the identification result may include a first position of each of the at least one target object in a first coordinate system.

Each target object may have a corresponding first position. For each target object, a first position of the target object may refer to a position of the target object in the first coordinate system.

The first coordinate system may refer to a coordinate system constructed based on the image. The processor may construct the first coordinate system in a plurality of ways. For example, the processor may determine a lower left corner of the image as an origin of first coordinate system, a lower edge of the image as an x-axis, a left edge as a y-axis, and construct the first coordinate system based on a predetermined proportional relationship between a pixel position and a coordinate position. The first coordinate system may be a two-dimensional coordinate system, a three-dimensional coordinate system, or the like. For example, when the image is a two-dimensional image, the first coordinate system may be a two-dimensional coordinate system.

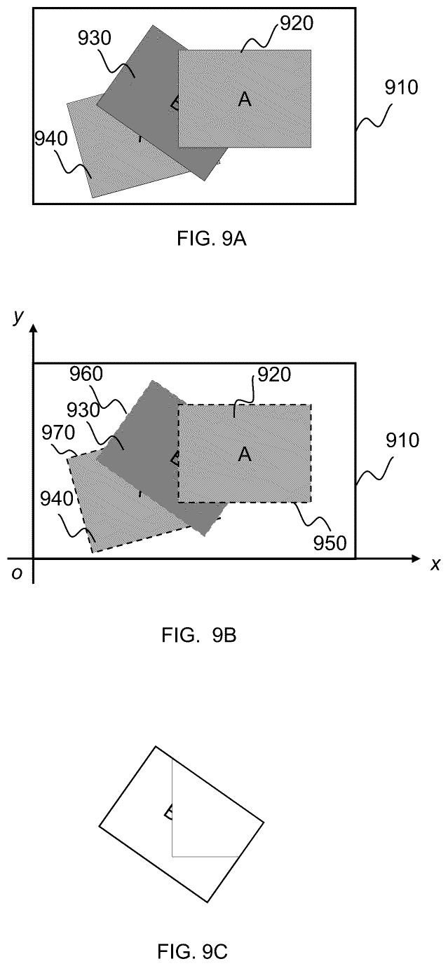

In some embodiments, for each of the at least one target object, a representation parameter of the first position of the target object may include a direction parameter of an object frame where the target object is located. The object frame may be a frame determined for each of the at least one target object when the identification model processes the image. For example, the object frame may be a frame of a minimum bounding rectangle of the target object. As shown in FIG. 9A, an image 910 may include a target object 920, a target object 930, and a target object 940. As shown in FIG. 9B, the object frames in which the target object 920, the target object 930, and the target object 940 are located may be an object frame 950, an object frame 960, and an object frame 970. In some embodiments, the direction parameter of the object frame where the target object is located may be determined based on an angle between a predetermined side of the object frame and the x-axis in the first coordinate system. As shown in FIG. 9B, the direction parameter of the object frame 950 may be determined to be 0° based on the angle between a long side of the object frame 950 and the x-axis of the first coordinate system. In some embodiments, the direction parameter of the object frame where the target object is located may be determined in other ways. For example, the direction parameter of the object frame where the target object is located may include angles formed by each side and the x-axis in the first coordinate system. Each side of sides may be formed by the origin of the first coordinate system and a vertice of four vertices of the object frame.

In some embodiments, for each of the at least one target object, a representation parameter of the first position of the target object may also include a plurality of position parameters of a plurality of key points of an object frame where the target object is located. The key point may be a point that can affect an appearance (a shape, a size, etc.) of an object frame. The plurality of key points in the object frame where the target object is located may be predetermined by the processor. The plurality of position parameters of the plurality of key points may be determined based on coordinates of the key points in the first coordinate system. For example, the plurality of key points in the object frame where the target object is located may include four vertices of the object frame. Correspondingly, the plurality of position parameters of the plurality of key points may include coordinates of each vertex in the object frame where the target object is located in the first coordinate system. As another example, the key points in the object frame where the target object is located may include a central point of the object frame, etc.

In some embodiments, for each of the at least one target object, the presentation parameter of the first position of the target object may also include a size of the object frame where the target object is located in the first coordinate system. That is, the presentation parameter of the first position of the target object may include a length and a width of the object frame.

In some embodiments, for each of the at least one target object, a representation parameter of the first position of the target object may also include a position parameter of the central point of the target object in the first coordinate system.

In some embodiments, the identification result may also include a category of each of the at least one target object. For example, the identification result may also include that a plurality of target objects in the image are all pickle packagings of a certain brand.

In some embodiments, the identification result may also include a confidence level of the identification result. For example, the identification result may include a confidence level of an output category.

In some embodiments, for each of the at least one target object, the identification result may include a plurality of position parameters of a plurality of key points of the object frame where the target object is located in the first coordinate system, a position parameter of the central point of the target object in the first coordinate system, a direction parameters of the object frame, a size of the object frame, a category of the target object and the confidence level thereof, etc., or any combination thereof. For example, the identification result may include a position of the central point of the target object, the direction parameter, and the size of the object frame where the target object is located. As another example, the identification result may include the plurality of position parameters of a plurality of key points of the object frame where the target object is located, the category, and the confidence level thereof.

In some embodiments, the identification result may be characterized by a target vector. A dimension of the target vector may be related to a type of relevant information in the identification result. For example, when the identification result is the coordinates, direction parameters, sizes a plurality of key points of the object frame where the target object is located, the position of the central point of the target object, the category, and the confidence level of the identification result, etc., in the first coordinate system, the target vector of a certain target object may be a 15-dimensional vector (x₀, y₀, w, h, θ, x₁, y₁, x₂, y₂, x₃, y₃, x₄, y₄, c, d), where x₀, x₁, x₂, x₃, x₄ respectively denote the x-axis coordinates of the central point of the target object and the four vertices of the object frame where the target object is located in the first coordinate system. y₀, y₁, y₂, y₃, y₄ respectively denote the y-axis coordinates of the central point of the target object and the four vertices of the object frame where the target object is located in the first coordinate system. w, h respectively denote the length and the width of the target object in the first coordinate system. θ denotes the direction parameter of the target object in the first coordinate system. c denotes the category of the target object. d denotes the confidence level of the identification result. It should be understood that the content in the target vector may be adaptively changed based on the relevant information contained in the identification result. For example, when the identification result merely includes the coordinates of the plurality of key points of the object frame where the target object is located in the first coordinate system, the target vector may be an 8-dimensional vector (x₁, y₁, x₂, y₂, x₃, y₃, x₄, y₄).

In some embodiments, the processor may determine an identification result by processing the image based on the identification model. The processor may preprocess the image, and remove background content that is not related to the at least one target object in the image. The processor may process the preprocessed image to determine the identification result. According to some embodiments of the present disclosure, the background content that is not related to the at least one target object in the image may be removed, so as to eliminate the influence of the background content in the image on the identification model, and ensure the accuracy of the identification result.

In some embodiments, the image may be input into the identification model, and an output of the identification model may the identification result. More descriptions regarding a process for processing the image based on the identification model may be found in FIG. 6 and relevant descriptions thereof.

In 520, the processor may determine, from the image, a target image of each of the at least one target object based on the first position of each of the at least one target object in the first coordinate system.

For each of the at least one target object, the target image may refer to an image of the target object in the image. The target image may be in one-to-one correspondence with the target object.

The processor may segment the image based on the first position of each of the at least one target object in the first coordinate system to determine, from the image, a target image of each of the at least one target object. In some embodiments, for each of the at least one target object, the processor may segment the image based on the object frame of the target object to obtain a target image of the target object.

In some embodiments, the processor may directly designate a segmented image as the target image of the target object. In some embodiments, if a target object is shielded by other target objects, other target objects may appear in the target image of the target object, that is, the target object in the target image may have a shielded area, the shielded area in the target image may be processed, and the processed target images may be used as the basis of the subsequent process. For example, the processed target image may be determined as a new target image to determine a second position of the target object. As another example, the new target image may be configured to determine a similarity between the new target image and a second reference image to determine an operating order. In some embodiments, the processing of the shielded area may include replacing the shielded area with a background. Features of the background may be quite different from features of the target object. As shown in FIG. 9B, the image 910 may be segmented based on the first position of the target object 930 in the first coordinate system to obtain a segmented image. Since the target object 930 is shielded by the target object 920, the shielded area in the segmented area, that is, a part of the target object 920, may be cropped. The shielded area may be filled with a predetermined white background to obtain a target image of the target object 930 in the image 910 as shown in FIG. 9C.

In some embodiments of the present disclosure, other target objects in the target image may be processed, so as to avoid the influence of other target objects on post-processing of the target image, which can effectively improve the accuracy of the method for positioning a target object.

In some embodiments, for each of the at least one target object, the processor may also adjust the object frame in which the target object is located based on the category of the target object, so that the adjusted object frame may be similar to the shape of the target object. For example, when the category of the target object is a pickle packaging of a certain brand, and the pickle packaging of the brand is a parallelogram, the processor may adjust, based on the category of the target object, the object frame where the target object is located from a rectangle to a parallelogram according to a predetermined correspondence relationship. Further, the processor may segment the image based on the adjusted object frame of the target object to obtain a target image of the target object.

In some embodiments of the present disclosure, the object frame where the target object is located may be adjusted based on the category of the target object, so that the adjusted object frame is similar to the shape of the target object, which can avoid the influence caused by the content that is not related to the target object in the target image during the post-processing, and improve the accuracy of positioning a target object.

In some embodiments, the processor may determine a first feature of the target image of each of the at least one target object. The processor may determine, based on a similarity between the first feature of the target image of each of the at least one target object and a second feature, an operating order in which the operating device works on the at least one target object. More descriptions regarding determining the operating order based on the similarity between the first feature the target image and the second feature of the second reference image may be found in FIG. 7 and relevant descriptions.

In 530, the processor may determine, based on a first reference image and the target image of each of the at least one target object, a second position of each of the at least one target object in a second coordinate system. The second position may be configured to determine operation parameters of an operating device.

The first reference image may refer to an image configured for transforming position coordinates of each target object in each target image into coordinates in the same coordinate system. The same coordinate system may be a second coordinate system determined by the first reference image. Objects in the first reference image may be complete, un-shielded, and unstacked. The object category in the first reference image may be the same as the category of the target object. The processor may construct the second coordinate system in a plurality of ways. For example, the processor may set a lower left corner of the first reference image as an origin, a lower edge of the first reference image as an x-axis, a left edge as a y-axis, and construct the second coordinate system based on a predetermined proportional relationship between a pixel position and a coordinate position. A direction of the coordinate axis in the second coordinate system and an actual direction of the operating device may be determined in advance. The second coordinate system may be a two-dimensional coordinate system, a three-dimensional coordinate system, or the like. For example, when the first reference image is a two-dimensional image, the second coordinate system may be a two-dimensional coordinate system.

Different categories of objects correspond to different first reference images. The first reference image of each type of object may be obtained by an obtaining image device in advance and stored (e.g., stored in a computer-readable storage medium). For example, when the image includes an image of a certain category of the target object on the conveyor belt, the processor may place an object of the category on the conveyor belt and photograph with a camera to obtain a first reference image of the target object of the category in advance, and store the first reference image and the category corresponding to the first reference image in the computer-readable storage medium. The processor may obtain, according to the category of the target object, the first reference image corresponding to the category of the target object.

The second position may refer to a position of each of the at least one target object in the second coordinate system. In some embodiments, for each target object, the processor may also convert, based on the second position of the target object in the second coordinate system, the second coordinate system into a coordinate system constructed based on an operating device according to a predetermined change relationship, so as to determine operation parameters of the operating device to work on the target object. The coordinate system constructed based on the operating device may be a three-dimensional coordinate system. The operation parameters may refer to parameters for processing at least one target object by the operating device. In some embodiments, the processor may determine, based on the second position of each of the at least one target object in the second coordinate system, operation parameters of the operating device according to a predetermined program.

In some embodiments, the processor may analyze and process the first reference image and each of the at least one target object by performing modeling or using various data analysis algorithms, such as a regression analysis, a discriminant analysis, etc., to determine the second position of each of the at least one target object in the second coordinate system.

In some embodiments, for each of the at least one target object, the processor may determine a transformation parameter by processing, based on a transformation model, the first reference image and the target image of the target object. The processor may convert, based on the transformation parameter, a third position of the target object in a third coordinate system into the second position. The third coordinate system may be determined based on the target image of the target object. More descriptions regarding the above embodiments may be found in FIG. 6 and relevant descriptions thereof.

In some embodiments, when the image includes a plurality of target objects, the processor may execute the process 500 only once to determine the operation parameters of the operating device. In some embodiments, after the operating device performs the operation each time, the processor may also obtain a new image and execute the process 500 again, so as to avoid the influence of other target objects in the image (e.g., displacement of other target objects) and interference to subsequent operations when the operating device works on a certain target object each time.

In some embodiments of the present disclosure, at least one target object in the image including at least one target object may be positioned and the second position of each of the at least one target object may be determined, so that the operation parameters of the operating device to perform the operation on the corresponding target object can be quickly and accurately determined, thereby avoiding manual adjustment of the position of the at least one target object, reducing labor costs, and realizing automated production.

FIG. 6 is a schematic diagram illustrating an exemplary identification model according to some embodiments of the present disclosure.

In some embodiments, the processor may determine an identification result by processing an image based on an identification model. As shown in FIG. 6, an input of the identification model 620 may include an image 610, and an output may include an identification result. The identification model 620 may include a feature extraction layer 621, a feature fusion layer 622, and an output layer 623.

The feature extraction layer may include a plurality of convolutional layers connected in series. The plurality of convolutional layers may process the image. The plurality of convolutional layers may output a plurality of graph features in one-to-one correspondence with the outputs of the plurality of convolutional layers. Each convolutional layer in the feature extraction layer may perform feature extraction on the image from different aspects (e.g., a color, a size, etc.). Parameters of each convolutional layer (e.g., a size of a convolution kernel, etc.) may be the same or different. In the plurality of convolutional layers in series, the output of the previous convolutional layer may be designated as the input of the subsequent convolutional layer. For example, when the feature extraction layer processes the image, feature extraction may be performed on the image by the plurality of convolutional layers in sequence. The first layer of convolutional layer in the feature extraction layer may perform feature extraction on the image to obtain corresponding graph features. At this time, the graph feature obtained by the first layer of convolutional layer may include detailed features in the image. A second layer of convolutional layer may perform feature extraction on the graph features after the first layer of convolutional layer is convoluted to obtain the corresponding graph features. At this time, although the graph features obtained by the second layer of convolutional layer lose part of the detailed features compared with the graph features obtained by the first layer of convolutional layer, macroscopic features of the image may be obtained, which may be beneficial to dig out essential information inside the image. A third layer of convolutional layer may perform feature extraction on the graph features after the second layer of convolutional layer is convoluted again, until all the convolutional layers in the feature extraction layer may be traversed to obtain a plurality of graphic features. As shown in FIG. 6, the input of the feature extraction layer 621 may be an image 610, and the output may be a plurality of graph features 630. The feature extraction layer 621 may include a convolutional layer 1, a convolutional layer 2, . . . , a convolutional layer n, where n is a positive integer. The convolutional layer 1, the convolutional layer 2, . . . , the convolutional layer n may sequentially process the input image 610 to obtain a graph feature 1, a graph feature 2, . . . , a graph feature n, respectively. In some embodiments, the feature extraction layer may be a pre-trained MobileNetV3 network.

In some embodiments, the feature fusion layer may fuse the plurality of graph features to determine a third feature of the image. The third feature may refer to a feature obtained by fusing the plurality of graph features of the image. The feature fusion layer may perform a multi-scale feature fusion on the plurality of graph features to obtain the third feature of the image. The feature fusion layer may be Feature Pyramid Networks (FPN). As shown in FIG. 6, inputs of the feature fusion layer 622 may include a plurality of graph features 630, i.e., a graph feature 1, a figure feature 2, . . . , a figure feature n, where n is a positive integer, and an output may be a third feature 640.

In some embodiments, the output layer may process the third feature to determine the identification result. For example, the output layer may be a neural network. As shown in FIG. 6, the input of the output layer may be the third feature 640, and the output may be the identification result 650. When the image 610 includes m target objects, correspondingly, the identification result 650 may include a target vector 1, a target vector 2, . . . , a target vector m, where m is a positive integer.

In some embodiments, the identification model may be obtained by a training process. A training sample may include at least one sample image, and each of the at least one sample image may include at least one sample object. Labels of the training sample may include a sample direction parameter of a sample object frame where each of at least one sample object is located and a plurality of sample position parameters of a plurality of sample key points of the sample object frame. The labels of the training sample may be obtained by labeling the sample image manually. The plurality of training samples may be input into an initial identification model, and a loss function may be determined based on the output of the initial identification model and the labels. Based on the loss function, parameters of each layer in the initial identification model may be iteratively updated until predetermined conditions are met, and a trained identification model may be obtained. The predetermined conditions may include a convergence of the loss function, a training period reaching a threshold, or the like.

In some embodiments, the loss function may include a first loss item and a second loss item. The first loss item may be determined based on the sample direction parameter, and the second loss item may be determined based on the sample position parameter. In some embodiments, the second loss function may be determined by a Wing Loss function. The loss function may be as shown in the equation (1):

Loss=Loss_{angle}+WingLoss(vertex) (1),
where Loss denotes the loss function, Loss_{angle} denotes the first loss item, and WingLoss(vertex) denotes the second loss item.

It should be understood that when the identification model is trained, due to the periodicity of an angle, the loss function may be difficult to converge. At the same time, if the identification model is trained directly through an anchor with a predetermined angle, calculation volume may be greatly increased. In some embodiments of the present disclosure, using the plurality of position parameters of the plurality of key points of the object frame to assist in the calculation of the loss function may constrain the generated object frame to control the shape after regression to remain a rectangle.

In some embodiments, when the identification result also includes a category of each of the at least one target object, correspondingly, the labels of the training sample may also include a category of each of the at least one sample object when the identification model is trained. When the identification result also includes a length and a width of each of the at least one target object in the first coordinate system, correspondingly, the labels of the training sample may also include a sample length and a sample width in the sample coordinate system of each of the at least one sample object when the identification model is trained. When the identification result also includes a position of a central point of each of at least one target object, correspondingly, the labels of the training sample may also include a position of a sample central point of each of the at least one sample object when the identification model is trained. The loss function may also be as shown in the equation (2):

Loss=Loss_{box}+Loss_{cis}+Loss_{angle}+WingLoss(vertex) (2),
where Loss denotes the loss function, Loss_{angle} denotes the first loss item, WingLoss(vertex) denotes the second loss item, Loss_{box} denotes the loss item related to the length, the width and the position of the central point of the target object, and Loss_{cis} denotes the loss item related to the category of the target object.

In some embodiments, the processor may also set a weight of each loss item in the loss function. For example, a weight of the first loss item may be smaller than a weight of the second loss item, so that the loss function may converge faster.

In some embodiments of the present disclosure, the target object may be positioned quickly and accurately, and the second position of each of the at least one target object may be determined by processing the image by a machine learning model (that is, an identification model), thereby improving the processing efficiency, and reducing the cost of manually adjusting the position of the at least one target object.

FIG. 7 is a flowchart illustrating an exemplary process 700 for determining an operating order in which an operating device works on a target object according to some embodiments of the present disclosure. As shown in FIG. 7, the process 700 may include the following operations.

In 710, a processor may determine a first feature of the target image of each of the at least one target image.

The first feature may refer to a feature of each of the at least one target image. For each of the at least one target image, the first feature may include a color feature, a shape feature, an angle feature, an edge feature, a texture feature of the target image, or the like, or any combination thereof.

In some embodiments, for each of the at least one target image, the processor may obtain, based on the target image, the first feature of the target image by a feature extraction model. The feature extraction model may be a machine learning model. The feature extraction model may extract a feature of the image to obtain the feature of the image. In some embodiments, an input of the feature extraction model may include a target image, and an output may include the first feature of the target image.

In some embodiments, the feature extraction model may be a pre-trained machine learning model. For example, the feature extraction model may be a pre-trained convolutional neural networks (CNN) model. For example, the feature extraction model may be obtained by a trained image classification model. An input of the image classification model may include an image, and an output may include a category of the object in the image. The image classification model may include a feature extraction layer and the feature extraction layer may be designated as a feature extraction model.

In some embodiments of the present disclosure, by obtaining the pre-trained feature extraction model, requirements for training samples may be reduced and the problem of difficulty in obtaining labels when the feature extraction model is directly trained may be solved.

In 720, the processor may determine, based on a similarity between the first feature of the target image of each of the at least one target object and a second feature, an operating order in which the operating device works on the at least one target object. The second feature may correspond to a second reference image.

Objects contained in the second reference image may be complete, clear, and un-shielded. Similar to the first reference image, a category of an object in the second reference image may be the same as a category of the target object. The second reference image may be the same as or different from the first reference image. For example, the first reference image may be an image captured by placing a single object level horizontally on a conveyor belt. The second reference image may be an image captured by placing an object at any other position or with other items between the object and the conveyor belt. The process for determining the second reference image may be similar to the process for determining the first reference image as illustrated in FIG. 5.

The second feature may refer to a feature of the second reference image. The second feature may include a color feature, a shape feature, an angle feature, an edge feature, a texture feature, etc. of the second reference image. In some embodiments, when the target object is an object including a plurality of surfaces, the second reference image may include a plurality of second sub-reference images. Each second sub-reference image may correspond to each surface. As shown in FIG. 9A, a target object 920, a target object 930, and a target object 940 may be products of a same category. The product of this category may have two different surfaces, a surface A and a surface B. Correspondingly, the second reference image corresponding to the product of this category may include two second sub-reference images. For each of the at least one target object, when the second reference image includes a plurality of second sub-reference images. Correspondingly, the second feature may correspond to a plurality of second sub-features. Each second sub-feature may correspond to each sub-reference image.

In some embodiments, the processor may input the second reference image into the feature extraction model. An output of the feature extraction model may include the second feature. When the second reference image includes a plurality of second sub-reference images, each second sub-reference image may be input into the feature extraction model to obtain a second sub-feature of the second sub-reference image.

In some embodiments, the processor may determine a similarity between the first feature and the second feature by processing the first feature and the second feature. The similarity between the first feature and the second feature may be determined based on a vector distance between the first feature and the second feature. The vector distance may be negatively correlated with the similarity. The greater the vector distance, the smaller the similarity. For example, a reciprocal of the vector distance may be designated as the similarity. The vector distance may include a Manhattan distance, a European distance, etc.

In some embodiments, when the second feature includes a plurality of second sub-features, the processor may determine the similarity between the first feature and the second feature based on a sub-similarity between the first feature and each of the plurality of second sub-features. Similarly, the processor may determine the similarity based on the vector distance. For example, the processor may select a greatest sub-similarity from a plurality of sub-similarities, and determine the largest sub-similarity as the similarity between the first feature and the second feature. As another example, the processor may determine a weighted sum of the plurality of sub-similarities, and determine a weighted sum result as the similarity between the first feature and the second feature. The weight of each sub-similarity may be pre-determined.

According to some embodiments of the present disclosure, by setting the plurality of second sub-reference objects, it is ensured that when the target object has the plurality of surfaces, the similarity between the first feature and the second feature of the target object can also be accurately determined, so as to further determine the operating order in which the operating device works on the at least one target object.

In some embodiments, for each target object, the greater the similarity between the first feature and the second feature of the target object, the higher the operating order in which the operating device works on the target object. In some embodiments, the processor may compare the similarity between the first feature and the second feature of the target image of each of the at least one target object in the image with a predetermined similarity threshold, and determine a target object whose similarity is greater than or equal to the predetermined similarity threshold as a candidate operating object. An operating order in which the operating device works on the operating object may be determined based on similarity. For example, the greater the similarity, the higher the operating order of the operating device. In some embodiments, when the operating device has completed operations of all candidate operating objects, the processor may obtain a new image and process the new image to determine a new round of candidate operating objects of the operating device and an operating order in which the operating device works on the new round of candidate operating objects.

In some embodiments, for each target object, the processor may determine, based on a confidence level of the target object in the identification result and the similarity between the first feature and the second feature of the target object, an operating order in which the operating device works on the target object. For example, for each target object, the greater a product between the confidence level of the target object in the recognition result and the similarity between the first feature and the second feature of the target object, the higher the operating order in which the operating device works on the target object.

In some embodiments, when similarities between the first features and the second features of a plurality of target objects are the same, the processor may mark the plurality of target objects, send the image to a target terminal, and determine an operating order in which the operating device works on the plurality of target objects in the image by manual annotation. The target terminal may refer to a terminal used by a user (e.g., an operator of a production line).

In some embodiments, the processor may adjust, based on a positional relationship between the target object and a reference plane in the target image, the second reference image, and further determine, the adjusted second reference image, and an operating order in which the operating device works on the target object. For example, for each target image, the processor may also input the target image and the second reference image into an orientation determination model. An output of the orientation determination model may be a height and an angle of the target object of the target image relative to the reference plane. The reference plane may refer to a plane where an object in the second reference image is located. For example, the reference plane may be a plane where a conveyor belt in a production line is located. The processor may adjust, based on the height and the angle determined by the orientation determination model, the second reference image to obtain a new second reference image. The processor may determine, based on the new second reference image and the target image, an operating order in which the operating device works on the at least one target object. The determining the operating order in which the operating device works on the target object based on the new second reference image and the target image may be found in FIG. 7 and relevant descriptions thereof.

The orientation determination model may be obtained by training. A training sample may include a second historical image and a first sample reference image of the second historical image. Both the second historical image and the first sample reference image may include an object of one same category. Labels of the training sample may include a height and an angle of an object in the second historical image relative to a plane where an object in the first sample reference image is located. The labels of the training sample may be obtained by manual annotation. The processor may input a plurality of training samples into an initial orientation determination model, determine a loss function based on the output and labels of the initial orientation determination model, and iteratively update parameters of the initial orientation determination model based on the loss function until predetermined conditions are met in order to obtain a trained orientation determination model.

According to some embodiments of the present disclosure, the second reference image may be adjusted to obtain the new second reference image. Based on the new second reference image, the similarity between the first feature and the second feature of the target image can be more accurately determined, thereby improving the accuracy of the operating order in which the operating device works on the at least one target object and ensuring the stability of the operation process.

In some embodiments, when the image includes a plurality of target objects, the process 500 may be executed once to determine the operating order in which the operating device works on the plurality of target objects, or when the operating device performs the operation each time, a new image may be obtained again, and the process 500 may be executed again to ensure the accuracy of the operating order.

It should be understood that the greater the similarity between the first feature and the second feature of the target image, the more similar the target object of the target image is to the object in the second reference image, that is, the smaller the shielded area of the target object. When there are a plurality of target objects in the image and there is overlap between the plurality of target objects, a target object with a smallest shielded area may be at the top of the plurality of target objects. Therefore, the operating device may first work on the target object with a smallest shielded area.

According to some embodiments of the present disclosure, by calculating the similarity between the first feature and the second feature of the target image, the operating order in which the operating device works on the at least one target object may be determined, so that the operating device can preferentially work on the unshielded target object, and continuously adjust the subsequent shielded target objects during the operation in order to avoid the scattering of other target objects caused by the direct operation of the shielded target objects, which ensures the stability and efficiency of the operation process.

FIG. 8 is a flowchart illustrating an exemplary process 800 for determining a second position of at least one target object in a second coordinate system according to some embodiments of the present disclosure. As shown in FIG. 8, the process 800 may include the following operations.

In 810, for each of at least one target object, the processor may determine a transformation parameter by processing, based on a transformation model, the first reference image and the target image of the at least one target object.

The transformation parameter may refer to a parameter that transform a position in a third coordinate system to a position in the second coordinate system. More descriptions regarding the third coordinate system may be found in the operation 820 and relevant descriptions thereof. The transformation parameter may be characterized as a transformation matrix. The transformation matrix may be a homography matrix H, which is denoted as:

$$H = [ \begin{matrix}{h}_{11} & {h}_{12} & {h}_{13} \\ {h}_{21} & {h}_{22} & {h}_{23} \\ {h}_{31} & {h}_{32} & 1\end{matrix} ]$$

The position in the third coordinate system may be converted into the position in the second coordinate system by the transformation matrix.

In some embodiments, for each of the at least one target object, inputs of the transformation model may include the first reference image and the target image of the at least one target object, and an output may be the transformation parameter. The transformation model may include an encoding layer and a conversion layer. In some embodiments, the transformation model may be a deep learning network. For example, the transformation model may be a Nomogram NET. The transformation model may use a 3*3 convolution kernel and use a Batch-Normalization (Batch Norm) and a Rectified Linear Unit (ReLU). The transformation model may include 8 convolutional layers. Counts of convolutional layers may be: 64, 64, 64, 64, 128, 128, 128, 128. There may also be a 2*2 max pooling layer with a stride of 2 after each 2 convolutional layers. The transformation model may also include 2 full connection layers. An input may be a 2-channel image. A cross-entropy may be a cost function during a training process. A last layer of the transformation model may be a softmax layer. The softmax layer may generate an 8-dimensional vector of confidence levels of each corner point.

In some embodiments, the encoding layer may process the target image to determine a first encoding vector. The first encoding vector may be a position vector obtained by encoding the third position of the target object in the target image in the third coordinate system. The third position may include a position of the target object in the target image in the third coordinate system. The third coordinate system may be determined based on the target image of the at least one target object. For example, the encoding layer may determine third positions of a plurality of points (e.g., at least 4 points) of the target object in the target image in the third coordinate system by processing the target image, and encode the third positions to obtain the first encoding vector.

In some embodiments, the encoding layer may also process the first reference image to determine a second encoding vector. The second encoding vector may be a position vector obtained by encoding the position of the object in the first reference image in the second coordinate system. For example, the encoding layer may determine positions of the plurality of points (e.g., at least 4 points) of the object in the first reference image in the second coordinate system by processing the first reference image, and encode the positions to obtain the second encoding vector.

In some embodiments, the conversion layer may process the first encoding vector and the second encoding vector to determine the transformation parameter. Inputs of the conversion layer may include the first encoding vector and the second coding vector. An output of the conversion layer may include the transformation parameter.

In some embodiments, the transformation model may be obtained by training. A training sample may include a third historical image and a second sample reference image. Both the third historical image and the second sample reference image may include an object of one same category. Training labels may include a difference between a position in a coordinate system of the third historical image and a position in the coordinate system of the second sample reference image when a position of each of the plurality of points of the object in the third historical image in the coordinate system of the third historical image is transformed to a position in the coordinate system of the second sample reference image. The processor may input a plurality of training samples into an initial transformation model, determine a loss function based on the output and the labels of the initial transformation model, and iteratively update parameters of the initial transformation model based on the loss function until predetermined conditions are met in order to obtain a trained transformation model. The predetermined conditions may include, but are not limited to the convergence of the loss function, a training period reaching a threshold, etc.

In 820, the processor may convert, based on the transformation parameter, a third position of the at least one target object in a third coordinate system into the second position. The third coordinate system may be determined based on the target image of the at least one target object.

In some embodiments, the third position of the target object may be determined in various ways. For example, for each target object, the processor may determine, based on the first position of the target object in the first coordinate system, the third position of the target object in the third coordinate according to a predetermined conversion relationship. As another example, the output of the transformation model may also include the third position of the target object in the third coordinate system. Correspondingly, the labels of the training sample may also include the position of each of the plurality of key points in the object frame where the object in the third historical image is located in the coordinate system of the third historical image when the transform model is trained.

It should be understood that for each target object, the target image is obtained by segmenting the image according to the first position of the target object, the first coordinate system is determined based on the image, and the third coordinate system is determined based on the target image of the at least one target object. As a result, the first coordinate system may be associated with the third coordinate system, and the specific conversion relationship thereof may predetermined.

In some embodiments, for each of the at least one target object, the processor may determine, based on the third position of the target object in the third coordinate system, the second position of the target object in the second coordinate system by processing through the transformation parameter. For example, based on the transformation matrix, a certain position in the third coordinate system may be converted into a position (x′, y′) in the second coordinate system:

$$[ \begin{matrix}{x}^{′} \\ {y}^{′} \\ 1\end{matrix} ] ∼ [ \begin{matrix}{h}_{11} & {h}_{12} & {h}_{13} \\ {h}_{21} & {h}_{22} & {h}_{23} \\ {h}_{31} & {h}_{32} & 1\end{matrix} ] [ \begin{matrix}x \\ y \\ 1\end{matrix} ]$$

According to some embodiments of the present disclosure, the transformation parameter may be obtained by the transformation model, and the third position of each target object may be converted into the second position based on the transformation parameter, thereby accurately determining the operation parameters of the operating device, avoiding the tedious target object calibration operation, and improving production efficiency.

In the different parts of the present disclosure, the target object may also be referred to as an object to be detected. The first reference image may also be referred to as a first image. The first feature may also be referred to as called a reference feature point template. The image may also be referred to as a second image. The target image may also be referred to as a second sub-image. The second feature may also be referred to as an extraction feature point. The feature extraction model may also be referred to as a feature extraction network. The second position may include a reference coordinate.

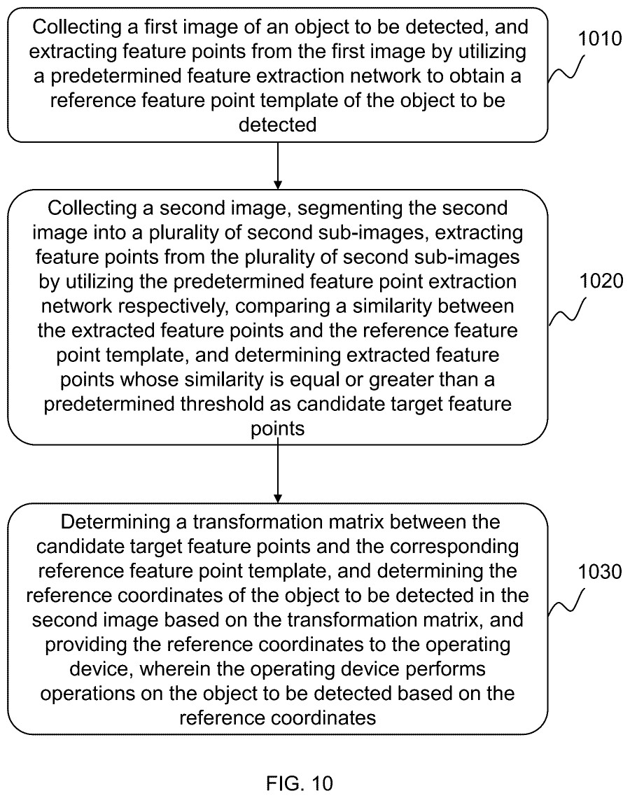

FIG. 10 is a flowchart illustrating an exemplary process for identifying and positioning a plurality of target objects according to some embodiments of the present disclosure. As shown in FIG. 10, the process for identifying and positioning a plurality of target object according to some embodiments of the present disclosure may include the following processing operations.

In 1010, a first image of an object to be detected may be collected, and feature points may be extracted from the first image by utilizing a predetermined feature extraction network to obtain a reference feature point template of the object to be detected.

In the embodiments of the present disclosure, the first image of the object to be detected may be a complete image under a condition of no shield. The reference feature point template may extract feature points by using a pre-trained CNN feature point extraction network to quickly determine a reference feature point template of the object to be detected. The reference feature point template may be configured to achieve the comparison and selection a preferred object to be detected, and to quickly identify the object to be detected. The reference feature point template may also be configured to calculate a transformation matrix with actually extracted feature points of the object to be detected to determine a reference coordinate of the object to be detected, and to provide the reference coordinate to an operating device such as a robotic arm to quickly grab a target object. The embodiments of the present disclosure may use a predetermined CNN trained with large samples, and may not need to collect sample data for corresponding training, which may have strong practicability.

In the embodiments of the present disclosure, the first image may be a 2D image, and the object to be detected may be photographed by a camera. First, the reference feature points of the object to be detected may be extracted as the basis for calculating the transformation matrix between the extraction feature points of the object to be grasped and the reference feature points.

In 1020, a second image may be collected. The second image may be segmented into a plurality of second sub-images. Feature points may be extracted from the plurality of second sub-images by utilizing the predetermined feature point extraction network respectively. A similarity between the extracted feature points and the reference feature point template may be compared, and extracted feature points whose similarity is equal to or greater than a predetermined threshold are determined as candidate target feature points.

In the present disclosure, the second image may be obtained by taking a 2D image of the object to be detected on the assembly line, such as a small commodity, and then feature points of the object to be detected may be extracted by using a neural network, so as to compare with the reference feature point template to determine the transformation matrix between the object to be detected and the reference feature point template and accurately determine the reference coordinates of the object to be detected relative to the operating device such as the robotic arm, which may be convenient for the robotic arm to grasp the object to be detected based on the reference coordinates, so as to realize the sorting of small commodities.

In 1030, a transformation matrix between the candidate target feature points and the corresponding reference feature point template may be determined, and the reference coordinates of the object to be detected in the second image may be determined based on the transformation matrix, and the reference coordinates may be provided to the operating device. The operating device may perform operations on the object to be detected based on the reference coordinates.

In the embodiments of the present disclosure, a virtual geometry group (VGG) network may be constructed. A convolution kernel of the VGG network may be N*N with at least M convolutional layers. A max pooling and two full connection layers may be provided after each two convolutional layers. N may be an integer greater than 2. M may be an integer greater than 3. Preferably, N may be 3. M may be 8.

A two-channel image may be input for training. A cross-entropy during a training process may be used as a cost function. A last layer may be a normalized exponential function, i.e., a softmax layer. The softmax layer may generate an M-dimensional vector of the confidence levels of each corner point.

The plurality of second sub-images may be respectively combined with the reference feature point templates to form pairs of images. The pairs of images may be input into the VGG network, and a reference feature point template may be regressed. A transformation matrix between the candidate target feature points and the reference feature point templates may be determined based on the displacement vector matrix.

In the embodiment of the present disclosure, representing the object to be detected as a vector of set dimensions may include: representing the object to be detected as a 13-dimensional vector {x, y, w, h, θ, x1, y1, x2, y2, x3, y3, x4, y4}, where x, y denotes coordinates of a central point of the object to be detected. w denotes a length of the object to be detected. h denotes a width of the object to be detected. θ denotes a tilt angle of the object to be detected. x1, y1, x2, y2, x3, y3, x4 and y4 denote four vertices in a clockwise direction of a rotation rectangle of the object to be detected, respectively. The tilt angle may be determined in radians with a tan h activation function, and a tilt angle may be in a range of [−1,1]. x1,x2, . . . x4,y4 may be the four vertices in the clockwise direction of the rotation rectangle. Loss of the four vertices of the rotation rectangle may be determined by using a commonly used loss function of face key points, i.e., a Wing Loss function. Correspondingly, the reference feature point template of the object to be detected may be obtained based on the vertex loss. The transformation matrix may be determined based on the vertex loss. Relative coordinates of the object to be detected may be determined more accurately by using the loss function.

The essence of the technical solutions of the embodiments of the present disclosure may be further illustrated below by specific examples.

In the embodiments of the present disclosure, achieving multi-target object positioning and a target output planning by using a deep learning technology to may mainly include: rotating a target positioning frame by using the deep learning detection network to obtain information such as positioning centers, angles, widths, heights, minimum bounding rectangles of all target objects; establishing a preferred un-shielded target template offline and establishing a feature point template; comparing the positioned candidate target feature points with the template feature points to select a corresponding count of target feature points according to actual needs, and outputting planned and sorted target feature points clearly; and calculating the matrix relationship between the target features of the object to be grasped and the corresponding reference feature points and providing the matrix relationship to the robotic arm to grab the object to be detected.

A target to be detected may be represented as a 13-dimensional vector {x, y, w, h, θ, x1, y1, x2, y2, x3, y3, x4, y4}, where x, y denotes coordinates of a central point of the target to be detected. w denotes a length of the target to be detected. h denotes a width of the target to be detected. θ denotes a tilt angle of the target to be detected, which may be determined in radians with a tan h activation function, and a tilt angle may be in the range of [−1,1]. x1, y1, x2, y2, x3, y3, x4 and y4 may be the four vertices in the clockwise direction of the rotation rectangle. In the embodiments of the present disclosure, loss of the four vertices of the rotation rectangle may be determined by using a commonly used loss function of face key points, i.e., a Wing Loss function.

The feature point template of the object to be detected may be extracted by using the pre-trained CNN feature point extraction network. The 2D image of the object to be detected may be segmented into a plurality of small images according to output coordinates. The feature points of the object to be detected in the plurality of small images may be extracted by using a predetermined CNN feature point extraction network, and a similarity between the features points of the object to be detected and the reference feature point template may be determined. The feature points whose similarity exceeds a set threshold, such as 70%, etc., may be determined as candidate target feature points. The candidate target feature points may be sorted in a descending order of similarity. A set count of candidate target feature points may be selected for outputting according to the sorting.

A direct matrix relationship between the current target object and the reference image may be determined by using a trained Nomography Net. The specific implementation is as follows:

A network with a structure similar to that of the VGG network may be constructed. A convolution kernel of the network is 3*3 with a Batch Norm and a ReLU. The network may include a total of 8 convolutional layers. Counts of each convolutional layer is respectively: 64, 64, 64, 64, 128, 128, 128, 128. There may be a max pooling (2*2, a stride of 2) after each two convolutional layers, and two full connection layers. A two-channel image may be input for training. A cross-entropy during a training process may be used as a cost function. A last layer may be a softmax layer, which may generate an 8-dimensional vector of confidence levels of each corner point. The embodiments of the present disclosure may use stacked small convolution kernels, which may be significantly better than using large convolution kernels, because multi-layer nonlinear layers may increase the network depth to ensure the learning of more complex patterns, and the cost parameter may be relatively small.

The plurality of small images obtained by segmentation may be combined with the reference feature point template to form a pair of images, which may be sent to a Deep Nomography network, and a displacement vector matrix may be regressed as H4 point. After these displacement vectors are obtained, Nomography may be further obtained, and the specific transformation matrix is as follows:

In the embodiments of the present disclosure, the 2D image may be used to detect the regression rotation rectangle of the target object, which can accurately position an actual position of the target object, and avoid the loss of the target object caused by the suppression of the regular rectangular frame after dense objects are detected. Through the preset feature point extraction network, a reference feature point template may be established, the similarity between the reference feature point and the feature point of the candidate target may be determined, and a relatively complete target object may be selected to ensure the robotic arm to effectively grasp subsequently. The homography matrix may be determined by the extracted target object and reference template feature points with no calibration and simple operation. In the embodiments of the present disclosure, the object to be detected may be identified and positioned by a 2D image, which can greatly reduce the calculation amount and improve the identification and positioning efficiency of the object to be detected.

It should be noted that the descriptions of the above processes is merely provided for the purposes of illustration, and not intended to limit the scope of the present disclosure. For those skilled in the art, multiple variations and modifications may be made to the processes under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

1. A method for positioning a target object, comprising:
determining an identification result by processing an image based on an identification model, wherein the identification result includes a first position of each of at least one target object in a first coordinate system;
determining, from the image, a target image of each of the at least one target object based on the first position of each of the at least one target object in the first coordinate system; and
determining, based on a first reference image and the target image of each of the at least one target object, a second position of each of the at least one target object in a second coordinate system, wherein the second position is configured to determine operation parameters of an operating device.

2. The method of claim 1, further comprising:
determining a first feature of the target image of each of the at least one target image; and
determining, based on a similarity between the first feature of the target image of each of the at least one target object and a second feature, an operating order in which the operating device works on the at least one target object, wherein the second feature corresponds to a second reference image.

3. The method of claim 2, wherein the first feature is obtained based on the target image through a feature extraction model, and the feature extraction model is a machine learning model.

4. The method of claim 1, wherein for each of the at least one target object, a representation parameter of the first position of the target object includes a direction parameter of an object frame where the target object is located.

5. The method of claim 4, wherein the representation parameters includes: a plurality of position parameters of a plurality of key points of the object frame.

6. The method of claim 5, wherein the identification model is obtained by a training process, labels in the training process include a sample direction parameter of a sample object frame where each of at least one sample object is located and a plurality of sample position parameters of a plurality of sample key points of the sample object frame; and
a loss function includes a first loss item and a second loss item, wherein the first loss item is constructed based on the sample direction parameter, and the second loss item is constructed based on the plurality of sample position parameters by a Wing Loss function.

7. The method of claim 1, wherein the identification model includes a feature extraction layer, a feature fusion layer, and an output layer; wherein
the feature extraction layer includes a plurality of convolutional layers connected in series, and the plurality of convolutional layers output a plurality of graph features;
the feature fusion layer fuses the plurality of graph features to determine a third feature of the image; and
the output layer processes the third feature to determine the identification result.

8. The method of claim 1, wherein the determining, based on the first reference image and the target image of each of the at least one target object, the second position of each of the at least one target object in the second coordinate system includes:
for each of the at least one target object,
determining a transformation parameter by processing, based on a transformation model, the first reference image and the target image of the target object; and
converting, based on the transformation parameter, a third position of the target object in a third coordinate system into the second position, wherein the third coordinate system is determined based on the target image of the target object.

9. The method of claim 8, wherein the transformation model includes an encoding layer and a conversion layer, wherein
the encoding layer processes the target image to determine a first encoding vector, and processes the first reference image to determine a second coding vector; and
the conversion layer processes the first encoding vector and the second encoding vector to determine the transformation parameter.

10. A system for positioning a target object, comprising:
at least one computer-readable storage medium including a set of instructions for positioning a target object; and
at least one processor in communication with the computer-readable storage medium, wherein when executing the set of instructions, the at least one processor is configured to:
determine an identification result by processing an image based on an identification model, wherein the identification result includes a first position of each of at least one target object in a first coordinate system;
determine, from the image, a target image of each of the at least one target object based on the first position of each of the at least one target object in the first coordinate system; and
determine, based on a first reference image and the target image of each of the at least one target object, a second position of each of the at least one target object in a second coordinate system, wherein the second position is configured to determine operation parameters of an operating device.

11. The system of claim 10, wherein the at least one processor is further configured to:
determine a first feature of the target image of each of the at least one target image; and
determine, based on a similarity between the first feature of the target image of each of the at least one target object and a second feature, an operating order in which the operating device works on the at least one target object, wherein the second feature corresponds to a second reference image.

12. The system of claim 11, wherein the first feature is obtained based on the target image through a feature extraction model, and the feature extraction model is a machine learning model.

13. The system of claim 10, wherein for each of the at least one target object, a representation parameter of the first position of the target object includes a direction parameter of an object frame where the target object is located.

14. The system of claim 13, wherein the representation parameters includes: a plurality of position parameters of a plurality of key points of the object frame.

15. The system of claim 14, wherein the identification model is obtained by a training process, labels in the training process include a sample direction parameter of a sample object frame where each of at least one sample object is located and a plurality of sample position parameters of a plurality of sample key points of the sample object frame; and
a loss function includes a first loss item and a second loss item, wherein the first loss item is constructed based on the sample direction parameter, and the second loss item is constructed based on the plurality of sample position parameters by a Wing Loss function.

16. The system of claim 10, wherein the identification model includes a feature extraction layer, a feature fusion layer, and an output layer; wherein
the feature extraction layer includes a plurality of convolutional layers connected in series, and the plurality of convolutional layers output a plurality of graph features;
the feature fusion layer fuses the plurality of graph features to determine a third feature of the image; and
the output layer processes the third feature to determine the identification result.

17. The system of claim 10, wherein the at least one processor is further configured to:
for each of the at least one target object,
determine a transformation parameter by processing, based on a transformation model, the first reference image and the target image of the target object; and
convert, based on the transformation parameter, a third position of the target object in a third coordinate system into the second position, wherein the third coordinate system is determined based on the target image of the target object.

18. The system of claim 17, wherein the transformation model includes an encoding layer and a conversion layer, wherein
the encoding layer processes the target image, determines the first encoding vector, and processes the first reference image of the description to determine the second coding vector; and
the conversion layer processes the first encoding vector and the second encoding vector to determine the transformation parameter.

19. (canceled)

20. A computer-readable storage medium storing a set of instructions, wherein when executed by at least one processor, the set of instructions direct the at least one processor to effectuate a method, the method comprising:
determining an identification result by processing an image based on an identification model, wherein the identification result includes a first position of each of at least one target object in a first coordinate system;
determining, from the image, a target image of each of the at least one target object based on the first position of each of the at least one target object in the first coordinate system; and
determining, based on a first reference image and the target image of each of the at least one target object, a second position of each of the at least one target object in a second coordinate system, wherein the second position is configured to determine operation parameters of an operating device.

21. The computer-readable storage medium of claim 20, wherein the method further comprises:
determining a first feature of the target image of each of the at least one target image; and
determining, based on a similarity between the first feature of the target image of each of the at least one target object and a second feature, an operating order in which the operating device works on the at least one target object, wherein the second feature corresponds to a second reference image.
